(19) United States
(12) Patent Application Publication
(10) Pub. No.: US 2009/0044770 A1
(43) Pub. Date: Feb. 19, 2009

(54) Camshaft phaser wiper seal with integral spring

(76) Inventors: Matthew T. Scott, Henrietta, NY (US); David M. McCarthy, Churchville, NY (US); Thomas H. Lichti, Victor, NY (US); Amanda M. Weiss, Livonia, NY (US)

Correspondence Address: DELPHI TECHNOLOGIES, INC., M/C 480-410-202, PO BOX 5052, TROY, MI, 48007, US

(21) Appl. No.: 11/891,765

(22) Filed: Aug. 13, 2007

(51) Int. Cl. F01L 1/344; F01D 11/00; F04D 29/00; F16J 15/16; F01L 1/34

(52) U.S. Cl. 123/90.17; 277/379; 74/568 R

(57) ABSTRACT

A wiper seal for preventing leakage of oil between advance and retard chambers formed between rotor vanes and stator lobes in a vane-type camshaft phaser is a monolithic structure made from a single material that includes a wiper element and a compressible spring element extending from the wiper element. The spring element is designed as a cantilevered arm and provides a sealing pressure to the wiper element. The wiper seal may further include a rib element as part of the monolithic structure that vertically extends the wiper element towards the spring element. The rib element assists in preventing over-compression of the cantilevered arm and in preventing tangling of a plurality of wiper seals during handling and shipping. The wiper seal is provided at the tip of each rotor vane and/or stator lobe of a vane-type camshaft phaser for varying the timing of combustion valves in an internal combustion engine.

### TECHNICAL FIELD

The present invention relates to hydraulic valve timing devices of internal combustion engines; more particularly, to vane-type camshaft phasers; and most particularly, to an improved compressible wiper seal for disposal in rotor vanes and/or stator lobes of a camshaft phaser.

### BACKGROUND OF THE INVENTION

Camshaft phasers for varying the phase relationship between the crankshaft and a camshaft of an internal combustion engine are well known. A prior art vane-type phaser generally comprises a plurality of outwardly extending vanes on a rotor interspersed with a plurality of inwardly extending lobes on a stator, forming alternating advance and retard chambers between the vanes and lobes. Engine oil is supplied via a multiport oil control valve (OCV), in accordance with an engine control module, to either the advance or retard chambers as required to meet current or anticipated engine operating conditions.

In a typical prior art vane-type camshaft phaser, also referred to herein simply as a cam phaser, the tip of each rotor vane and stator lobe is provided with a compressible radial seal for wiping the cylindrical wall of the opposite member, such as the stator wall and/or rotor hub, to prevent leakage around the rotor between the advance and retard chambers. Therefore, wiper seals provide a dynamically seal between two hydraulic chambers, which are pressurized in an alternating fashion. Typical cam phaser wiper seals consist of two components each made out of a different material.

A first known wiper seal utilizes a two-piece construction consisting of a plastic wiper blade and backing spring disposed within the vane or lobe to load the wiper blade against the stator or rotor surface.

A second known wiper seal utilizes a two-piece seal disposed in an axially extending groove formed in the vane or lobe tip. Typically, an elastomeric spring is over-molded onto a rigid plastic wiper-shaped substrate. The elastomeric spring is molded in place onto the substrate during an elastomer insert molding process where the wiper-shaped substrate is exposed to molding pressures and temperatures. This configuration requires two separate manufacturing steps, one successive assembly step, and two different materials to provide a one-piece wiper seal subassembly, creating undesired manufacturing and subassembly costs as well as complexity.

What is needed in the art is an improved wiper seal that is of one-piece construction manufactured in a single step and that does not need to be assembled.

What is further needed in the art is an improved wiper seal that is simple and inexpensive to manufacture, is durable, and is self-actuating to urge itself continuously against a stator or rotor wall.

It is a principal object of the present invention to reduce the complexity of a wiper seal and to improve the reliability of a wiper seal in a vane-type camshaft phaser.

It is a further object of the present invention to reduce the manufacturing cost of a cam phaser wiper seal, to reduce processing steps and process cycle time, and to reduce the amount of error-proofing needed on the assembly line.

### SUMMARY OF THE INVENTION

Briefly described, a wiper seal for preventing leakage of oil between advance and retard chambers formed between rotor vanes and stator lobes in a vane-type camshaft phaser in accordance with the invention combines a spring element and a wiper element in a monolithic structure and is manufactured from a single composite material by injection molding. The wiper seal is provided at the tip of each rotor vane and/or stator lobe of a vane-type camshaft phaser for varying the timing of combustion valves in an internal combustion engine. The vane-type camshaft phaser includes a rotor having a plurality of vanes disposed in a stator having a plurality of lobes, the interspersion of vanes and lobes defining a plurality of alternating valve timing advance and valve timing retard chambers with respect to the engine crankshaft. During rotation of the rotor within the stator, the tips of the vanes sweep past concave cylindrical walls of the stator, and the tips of the lobes sweep past convex cylindrical walls of the rotor hub. In the case where wipers are provided at both the stator wall and rotor hub positions, each vane and lobe tip is provided with an axially extending groove. The wiper seal in accordance with the invention is disposed in the groove for wiping the opposing wall, such as the stator wall and/or rotor hub. The wiper seal in accordance with the invention is designed as a potential drop-in replacement for existing prior art wiper seals, thereby eliminating the need for changing the design of the vane and lobe tips.

The wiper seal in accordance with the invention includes a spring element that is designed as a cantilevered arm and provides sealing pressure to the wiper element. The cantilevered arm is positioned on the back of the wiper element and comes in contact with the wiper element at a secondary contact point during installation forming an arch. The secondary contact point increases a sealing force across the face of the wiper compared to prior art wiper seals thereby providing improved reliability. The secondary contact point also distributes the sealing force across the face of the wiper evenly and prevents over-travel and over-stress of the cantilevered arm.

The wiper seal in accordance with the invention further includes a rib element that extends the back of the wiper element and that is positioned under the cantilevered arm. The rib element assists in preventing over-compression of the cantilevered arm and in preventing tangling of a plurality of wiper seals during handling and shipping.

By designing the wiper seal in accordance with the present invention as a monolithic structure manufactured from a single composite material during a single manufacturing step, the manufacturing costs and process cycle time can be reduced compared to prior art wiper seals based on elimination of plasma treatment and elastomer insert molding steps. Lower cost materials can be used in the wiper seal in accordance to the present invention compared to prior art, wiper seals due to elimination of the exposure of the material to plasma treatment and elastomer insert molding pressures and temperatures. Furthermore, it is believed that the composite material used in accordance with the present invention exhibits better wear characteristics against aluminum than material used for known prior art wiper elements.

### BRIEF DESCRIPTION OF THE DRAWINGS

The present invention will now be described, by way of example, with reference to the accompanying drawings, in which:

FIG. 1 is an axial-transverse cross-sectional view of a typical prior art vane-type camshaft phaser;

FIG. 2 is an isometric view of a wiper seal in accordance with the invention;

FIG. 3 is a cross-sectional side view of the wiper seal shown in FIG. 1 in accordance with the invention;

FIG. 4 is a plan side view of the wiper seal shown in FIG. 1 in installed position in accordance with the invention;

FIG. 5 is an isometric view of another wiper seal in accordance with the invention;

FIG. 6 is an isometric view of another wiper seal in accordance with the invention;

FIG. 7 is an isometric view of another wiper seal in accordance with the invention;

FIG. 8 is an isometric view of another wiper seal in accordance the invention; and

FIG. 9 is an isometric view of another wiper seal in accordance with the invention.

Corresponding reference characters indicate corresponding parts throughout the several views. The exemplification set out herein illustrates one preferred embodiment of the invention, in one form, and such exemplification is not to be construed as limiting the scope of the invention in any manner.

### DESCRIPTION OF THE PREFERRED EMBODIMENTS

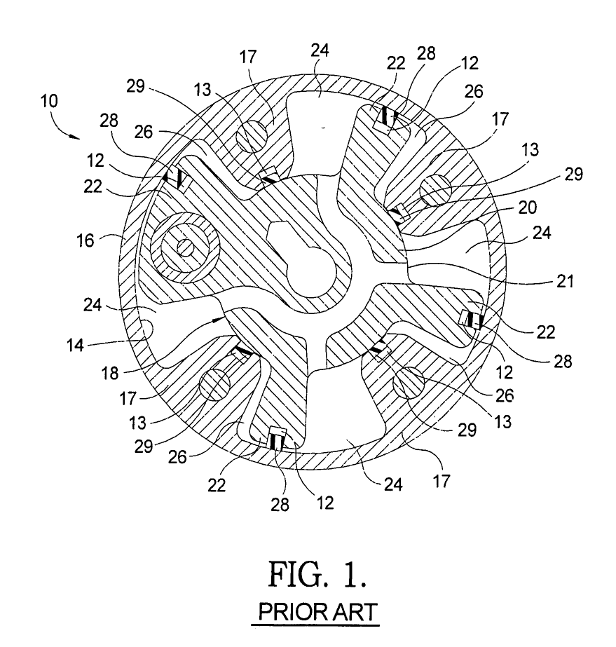

Referring to FIG. 1, an exemplary prior art vane-type camshaft phaser 10 for advancing and retarding the timing of valves of an internal combustion engine includes well-known generic components: a stator 16 having a plurality of inwardly extending lobes 17; a rotor 18 having a cylindrical hub 20 and a plurality of outwardly extending vanes 22; and a plurality of advance chambers 24 and retard chambers 26 being formed between the rotor vanes 22 and the stator 16. The lobes 17 are circumferentially spaced apart for receiving rotor 18. Vanes 22 extend into spaces between lobes 17. Hydraulic advance chambers 24 and retard chambers 26 are thus formed between lobes 17 and vanes 22. Each rotor vane 22 is provided with an axial groove 12 along the vane tip for receiving a resilient seal element 28 for sealingly wiping a cylindrically concave inner wall 14 of stator 16. Likewise, each stator lobe 17 is provided with an axial groove 13 along the lobe tip for receiving a resilient seal element 29 for sealingly wiping a cylindrically convex outer wall 21 of the rotor hub 20. Consequently, seal element 28 and seal element 29 prevent leakage of oil between advance chambers 24 and retard chambers 26.

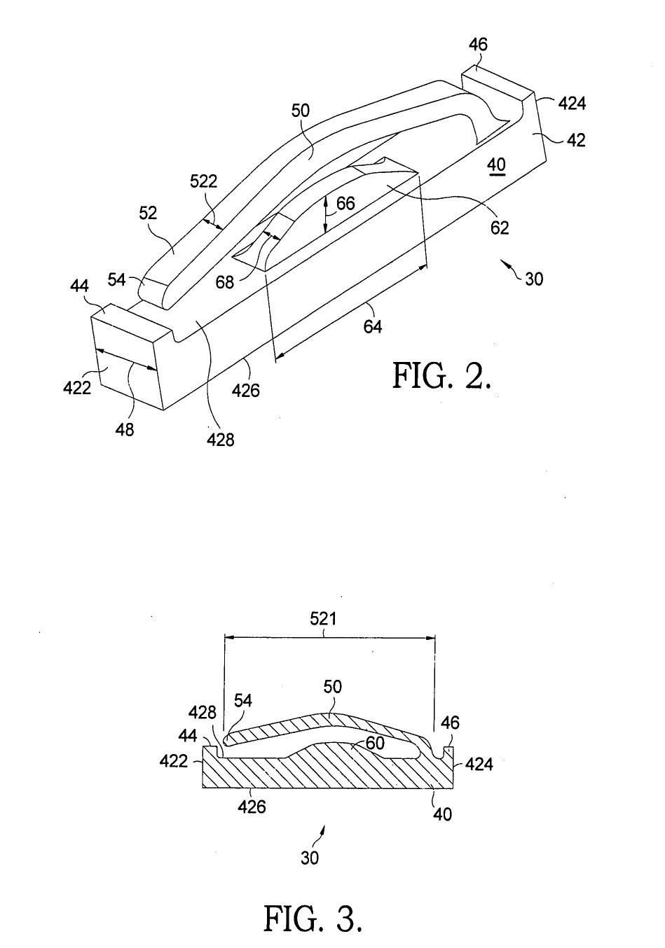

Referring to FIGS. 2 through 4, an improved compressible monolithic wiper seal 30 for disposal in rotor vanes and/or stator lobes of a vane-type camshaft phaser, such as camshaft phaser 10 shown in FIG. 1, is shown. It should be recognized that the improved wiper seal 30, as well as alternate designs 310, 320, 330, 340, and 350 of wiper seal 30, disclosed herein are equally suitable as a direct replacement for either of prior art vane seal element 28 or prior art lobe seal element 29 without modification of prior art vane groove 12 and prior art lobe groove 13 in accordance with the invention as described herein below.

The wiper seal 30 includes a wiper element 40, a compressible spring element 50, and a rib element 60. Wiper seal 30 combines wiper element 40, spring element 50, and rib element 60 in a monolithic structure that is formed of a single material.

In a currently-preferred method of manufacturing, wiper seal 30 is formed from a plastic composite material, such as the thermoplastic compound polyphthalamide (PPA). PPA is a thermoplastic synthetic resin of the nylon family suitable for high temperature applications. PPA is a high performance polyamide having a modulus higher than 1000 kpsi (kilo pound per square inch), and inheriting good high-temperature dimensional stability. PPA is classified as engineering plastic and is commercially available from a variety of suppliers. Although, PPA is a presently preferred material, it is understood that other materials may be used. The material used to manufacture wiper seal 30 should be selected according to wear characteristics, is stress and strain capabilities, ductility, and flexibility. Since wiper seal 30 is operated at elevated temperatures, maximum dimensional stability and, therefore, minimum post-mold shrinkage, is essential. To insure that no dimensional bias is introduced by moisture, wiper seal 30 should contain less than about 0.3% moisture by weight when measured. Wiper seal 30 is preferably manufactured as a monolithic structure during a single manufacturing step, such as an injection molding process. Other manufacturing processes including multi-step manufacturing processes may be used to form wiper seal 30.

Still referring to FIGS. 2-4, wiper element 40 includes a body 42 that extends axially from a first end 422 to a second end 424 and that has an outer surface 426 and an inner surface 428 and a width 48. Body 42 may have a generally rectangular cross-section in an axial direction and generally rectangular cross-section in a vertical direction (FIG. 2). At the first end 422 and the second end 424, wiper element 40 includes a first tab 44 and a second tab 46, respectively. Tabs 44 and 46 extend vertically from inner surface 426 of body 42. In a typical application, outer surface 428 of wiper seal 40 sealingly wipes a cylindrically concave wall 14 of stator 16 and/or cylindrically convex outer wall 21 of rotor hub 20, as shown in FIG. 1.

Spring element 50 includes a cantilevered arm 52 that extends generally vertically from inner surface 428 of wiper element 40 proximate to second end 424 and next to second tab 46. Also, cantilevered arm 52 extends axially towards first end 422 and first tab 44 of body 42 without reaching first tab 44. Even though not shown, cantilevered arm may also extend from inner surface 428 proximate to first end 422 and next to first tab 44. Cantilevered arm 52 includes a tip 54 positioned opposite from the point where arm 52 extends from body 42 of wiper element 40. Cantilevered arm 52 operates as a spring to provide sealing pressure to wiper element 40. Cantilevered arm 52 is illustrated in FIGS. 2 and 3 to be evenly curved over the entire length 521, to have a generally constant width 522 over the entire length 521, and to have a generally constant cross-section in axial direction.

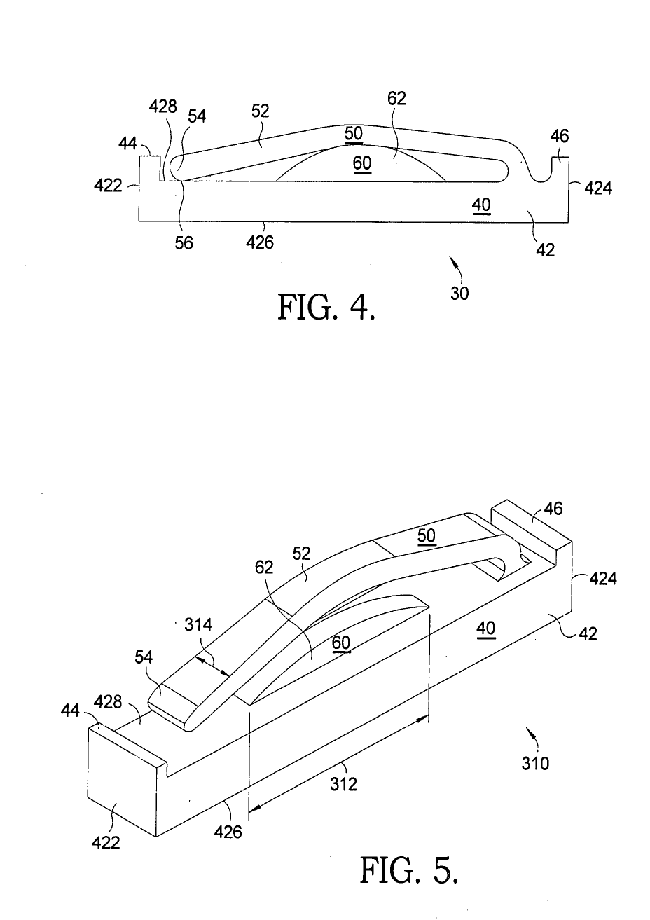

In a relaxed position shown in FIGS. 2 and 3, tip 54 of cantilevered arm 52 does not contact inner surface 428 of wiper element 40. During installation in a cam phaser, such as cam phaser 10 shown in FIG. 1, cantilevered arm 52 is bent towards body 42 of wiper element 40. In an installed position, which is also the position wiper seal 30 is in during operation of the cam phaser, shown in FIG. 4, tip 54 of cantilevered arm 52 contacts body 42 at a secondary contact point 56 forming an arch. The secondary contact point 56 assists in increasing the sealing force while evenly distributing the sealing force across body 42 of wiper element 40. Also, secondary contact point 56 prevents over-travel and over stress of cantilevered arm 52.

Rib element 60 includes a central rib 62 that extends vertically from inner surface 428 of body 42 of wiper element 40 towards cantilevered arm 52 and is axially positioned between first tab 44 and second tab 46, preferably centered between both tabs. Central rib 62 may be positioned between inner surface 428 of wiper element 40 and cantilevered arm 52 of spring element 50. Central rib 62 is enclosed by the arch formed by cantilevered arm 52 and may be in contact with the arm 52 in the installed position, as shown in FIG. 4. Central rib 62 may have, but is not limited to, a generally curved shape. Central rib 62 extends axially for a length 64 and has a height 66.

Height 66 is determined by the degree of compression of cantilevered arm 52. Central rib 62 has a width 68 that may be less or the same as width 48 of body 42. Rib element 60 assists in preventing over-compression of cantilevered arm 52. Furthermore, rib element 60 prevents tangling of a plurality of wiper seals 30 during handling and shipping.

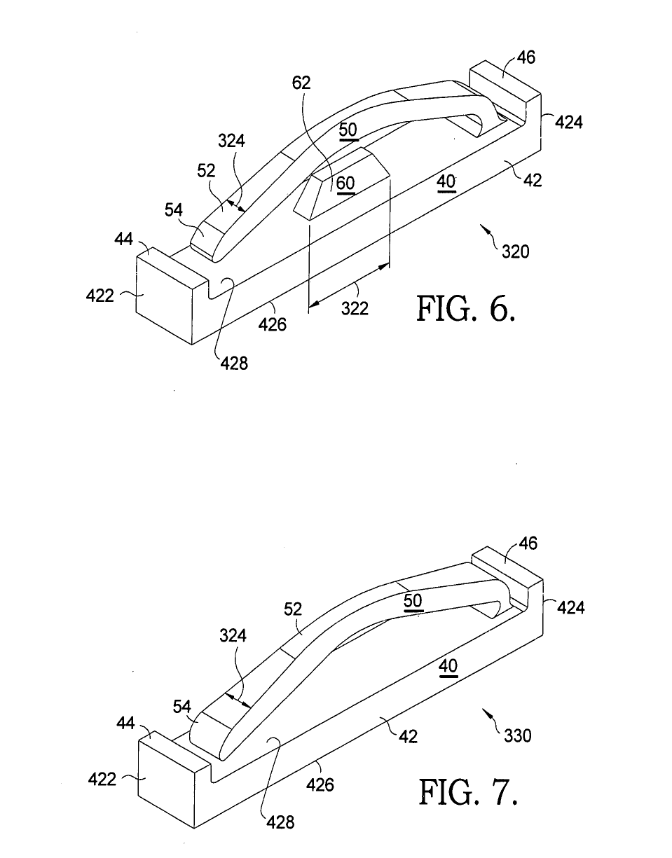

Referring now to FIGS. 5 through 9, alternate designs 310, 320, 330, 340, and 350 of wiper seal 30 in accordance with the invention are shown, respectively. As illustrated in FIG. 5, wiper seal 310 includes a central rib 60 that extends axially for a length 312 that is longer than length 64 shown in FIG. 2. Wiper seal 320 is shown in FIG. 6 to include a central rib 62 that has a length 322 that is shorter than length 64 shown in FIG. 2. Central rib 62 of wiper seal 320 is also shown to have a generally polygonal shape. Therefore, central rib 62 may have any length that can be enclosed by the arch formed by the cantilevered arm 52 in installed position (FIG. 4). Furthermore, central rib 62 may have any shape that can be enclosed by the arch formed by the cantilevered arm 52 in installed position (FIG. 4) and does not interfere with the compression of the cantilevered arm 52 other than limiting the degree of compression.

Another alternate design of wiper seal 30 is illustrated in FIGS. 7-9. FIGS. 7-9 show wiper seal 330, 340, and 350, respectively, which only include wiper element 40 and spring element 50. Rib element 60 has been eliminated.

Cantilevered arm 52 is shown in FIG. 5 to have a constant width 314 that is larger than width 522 shown in FIG. 2. Cantilevered arm 52 is shown in FIGS. 6 and 7 to have an irregular width 324 and 334, respectively. Width 324 and 334 is shown to be wider proximate to tip 54 and proximate to the intersection of arm 52 with body 42 than in the center.

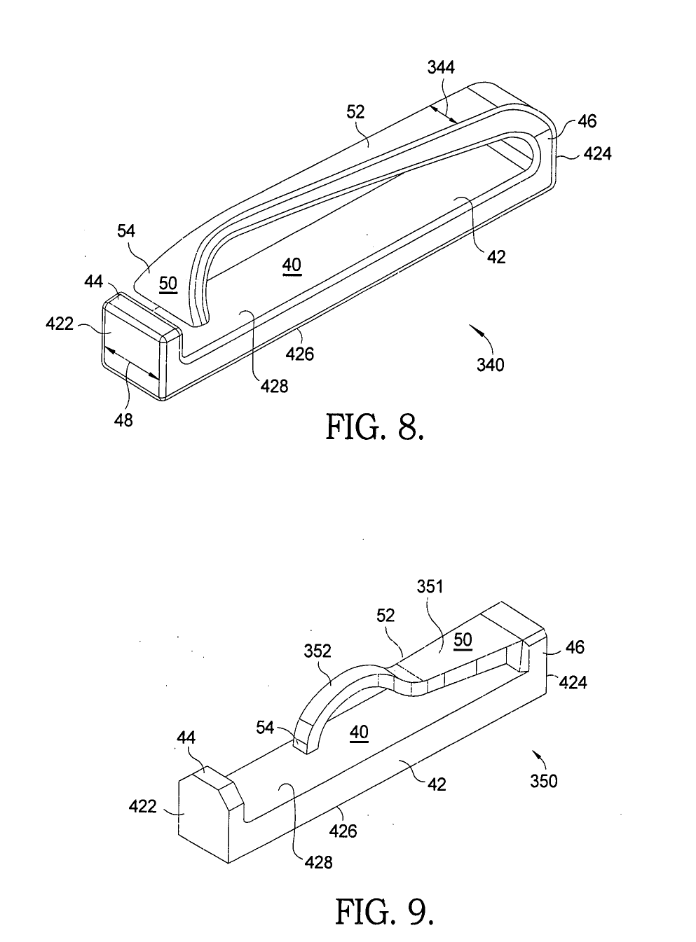

As shown in FIGS. 8 and 9, cantilevered arm 52 of wiper seal 340 and cantilevered arm 52 of wiper seal 350 extend from second tab 46 of body 42 rather than directly from body 42 as shown in FIGS. 2-7. The cantilevered arm 52 of wiper seal 340 (FIG. 8) has a generally straight shape, has an irregular width 344, and includes a tip 54 that has about the same width 48 as wiper element 40, and, therefore, is wider than the tip 54 shown in FIGS. 2-7. Cantilevered arm 52 of wiper seal 350, as shown in FIG. 9, includes a generally straight section 351 extending from the second tab 46 and a generally curved section 352 leading to tip 54. The length of the straight section 351 and the length of the curved section 352 may be varied. Also shown in FIG. 9 is a first tab 44 of the wiper element 40 that has a polygonal cross-section in a vertical direction that is different from a rectangular cross-section.

All wiper seals illustrated including a rib element 60, such as wiper seal 30, 310, and 320, may be manufactured without a rib element 60 and all wiper seals illustrated without rib element 60, such as wiper seal 330, 340, and 350, may be manufactured including rib element 60. Furthermore, all other shown alternative features may be applicable to any of the shown wiper seal configurations.

In some camshaft phasers, wiper seals are required on only the rotor vanes and are omitted from the stator lobes. Such phasers are fully comprehended by the present invention.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A wiper seal for application in a vane-type camshaft phaser, comprising:
a wiper element; and
a compressible spring element extending from said wiper element;
wherein said spring element and said wiper element are part of a monolithic structure made of a single material.

2. The wiper seal in accordance with claim 1, wherein said wiper element and said spring element are manufactured in a single manufacturing step.

3. The wiper seal in accordance with claim 1, further including a rib element vertically extending from said wiper element towards said spring element, wherein said rib element is part of said monolithic structure.

4. The wiper seal in accordance with claim 1, wherein said spring element includes a cantilevered arm that is bendable towards said wiper element.

5. The wiper seal in accordance with claim 1, wherein said wiper element includes a body that extends axially from a first end to a second end and that has an outer surface and an inner surface, and wherein said outer surface sealingly wipes walls of said camshaft-phaser.

6. The wiper seal in accordance with claim 5, wherein said spring element extends from said inner surface proximate to said second end and extends axially towards said first end.

7. The wiper seal in accordance with claim 1, wherein said spring element includes a tip positioned opposite from the point where said spring elements extends from said wiper element, and wherein said tip contacts said spring element when installed in said camshaft phaser.

8. The wiper seal in accordance with claim 1, wherein said spring elements provide a sealing pressure to said wiper element.

9. The wiper seal in accordance with claim 1, wherein said monolithic structure is formed of a plastic composite material.

10. The wiper seal in accordance with claim 1, wherein said monolithic structure is formed during an injection molding process in a single step.

11. A compressible wiper seal for preventing leakage of oil between advance and retard chambers formed between rotor vanes and stator lobes in a vane-type camshaft phaser, comprising:
a wiper element including a body having an outer surface, an inner surface, a first end, and a second end;
a compressible spring element including an cantilevered arm that extends from said inner surface of said wiper element proximate said second end and that extends axially towards said first end; and
a rib element including a central rib that extends from said inner surface of said wiper element towards said spring element;
wherein said spring element, said wiper element, and said rib element are combined in a monolithic structure made of a single material.

12. The compressible wiper seal in accordance with claim 11, wherein said body of said spring element further includes a first tab proximate to said first and end a second tab proximate to said second end, and wherein said first and second tab extend vertically from said inner surface.

13. The compressible wiper seal in accordance with claim 11, wherein said central rib is centered between said first end and said second end of said body.

14. The compressible wiper seal in accordance with claim 11, wherein said central rib has a shape that is selected from the group consisting of generally curved shape and generally polygonal shape.

15. The compressible wiper seal in accordance with claim 11, wherein said cantilevered arm is bendable towards said body of said wiper element and includes a tip that contacts said body of said wiper element at a secondary contact point forming an arch when bent towards said wiper element, and wherein said secondary contact point prevents over-travel and over-stress of said cantilevered arm.

16. The compressible wiper seal in accordance with claim 11, wherein said cantilevered arm is evenly curved over the entire length.

17. The compressible wiper seal in accordance with claim 11, wherein said outer surface of said body of said wiper element sealingly wipes a cylindrically concave wall of said stator or a cylindrically convex wall of a hub of said rotor.

18. A vane-type camshaft phaser for advancing and retarding the timing of valves of an internal combustion engine, comprising:
a first element including an axial groove along the tip thereof;
a wiper seal including a wiper element, and a compressible spring element extending from said wiper element, wherein said spring element and said wiper element are part of a monolithic structure made of a single material, and wherein said spring element is inserted into said groove and compressed such that said wiper element makes contact with an opposing wall of a second phaser element.

19. The vane-type camshaft phaser according to claim 18, wherein said first phaser element is selected from the group consisting of rotor vane and stator lobe, and wherein said second phaser element is selected from the group consisting of stator wall and rotor hub.

20. The vane-type camshaft phaser according to claim 18, wherein said wiper seal further comprises a rib element vertically extending from said wiper element towards said spring element, wherein said rib element is part of said monolithic structure.
